(19) United States
(12) Patent Application Publication
(10) Pub. No.: US 2026/0329116 A1
(43) Pub. Date: Oct. 22, 2026

(54) Optical Control Element, Optical Modulation Device Using Optical Control Element, and Optical Transmission Apparatus

(71) Applicant: SUMITOMO OSAKA CEMENT CO., LTD., Tokyo (JP)

(72) Inventors: Katsutoshi KONDO, Tokyo (JP); Junichiro ICHIKAWA, Tokyo (JP)

(21) Appl. No.: 19/435,200

(22) Filed: Dec. 29, 2025

(30) Foreign Application Priority Data
Feb. 27, 2025 (JP) 2025-030233

(51) Int. Cl. G02F 1/035

(52) U.S. Cl. CPC G02F 1/035; G02F 2202/20

(57) ABSTRACT

An optical control element includes an electro-optical substrate that contains lithium and in which an optical waveguide is formed, and electrodes that apply an electric field to the optical waveguide, in which a diffusion layer (transparent conductive film) into which lithium contained in the electro-optical substrate is able to diffuse is disposed in the vicinity of the electro-optical substrate, and a block layer that suppresses diffusion of lithium is disposed between the electro-optical substrate and the diffusion layer.

### CROSS-REFERENCE TO RELATED APPLICATIONS

This application claims the benefit of Japanese Patent Application No. 2025-030233 filed Feb. 27, 2025, the disclosure of which is herein incorporated by reference in its entirety.

### BACKGROUND OF THE INVENTION

### Field of the Invention

The present invention relates to an optical control element, an optical modulation device using the optical control element, and an optical transmission apparatus, and particularly to an optical control element including an electro-optical substrate that contains lithium and in which an optical waveguide is formed, and electrodes that apply an electric field to the optical waveguide, an optical modulation device using the optical control element, and an optical transmission apparatus.

### Description of Related Art

In recent years, a new platform that uses thin-film lithium niobate (thin-film LiNbO₃, TFLN) as an optical waveguide for optical communications has attracted attention. In addition, as disclosed in Japanese Patent Application No. 2023-216412 (filing date: Dec. 22, 2023), the development of optical control elements incorporating multifunctional optical circuits has been accelerating through the integration of heterogeneous materials such as TFLN, Si, and SiN.

Optical control elements such as lithium niobate (LN) optical modulators (LN modulators) employ the Pockels effect, and produce refractive index changes (electro-optic effects, EO effects) proportional to the electric field applied to the LN. In order to lower a drive voltage of the LN modulator, the electric field is further increased by narrowing a gap between the electrodes (modulation electrodes or the like). The control electrode is generally made of metal, and when a gap between the control electrodes is narrowed, the metal absorbs light propagating through the optical waveguide, and thus an optical insertion loss, which is one of the characteristics of the optical modulator, increases. Therefore, in a case where a length of the electrode is constant, there is a trade-off relationship between lowering the drive voltage of the LN modulator and the optical insertion loss.

In addition, in bias point control of the LN modulator, not only the electro-optic effect but also a thermo-optic effect (TO effect) can be used. This exploits the fact that the refractive index varies depending on a temperature, and can be achieved by causing a current to flow through a heater electrode disposed in the vicinity of the optical waveguide. In order to efficiently change the refractive index of the optical waveguide, it is necessary to bring the heater electrode as close as possible to the optical waveguide, so that there is a trade-off relationship between reducing a control current and the optical insertion loss, with the EO effect.

As a method of improving the above-described trade-off relationship, a method of using a transparent electrode has been proposed as disclosed in Japanese Laid-open Patent Publication No. 2008-250080. As shown in FIG. 1, electrodes 3 are formed on an electro-optical substrate 1 in which an optical waveguide WG is formed, and a transparent conductive film 4 is disposed below the electrodes 3. Reference numeral 2 denotes a support substrate that supports the electro-optical substrate 1.

Xiangyu Meng, et al., “High Performance Thin-film Lithium Niobate Modulator Applied ITO Composite Electrode with Modulation Efficiency of 1V·cm”, Cornell University, arXiv:2311.05119, Submitted on 9 Nov. 2023, URL: https://arxiv.org/abs/2311.05119 also reports that a trade-off relationship is improved and a wideband operation is performed with the same structure. In C. M. Gee, et al., “Minimizing dc drift in LiNbO₃ waveguide devices”, Applied Physics Letters, Vol. 47, No. 3, page 211 to 213(1985 ), a DC drift is suppressed by inserting indium tin oxide (ITO), which is a transparent conductive film, between an LN substrate (Ti-diffused LN waveguide) formed by Ti diffusion and a metal electrode. It has also been reported that the optical insertion loss increases by inserting ITO.

Pamphlet of International Publication No. WO2006/004139A1 and Japanese Laid-open Patent Publication No. 2007-272122 disclose an LN modulator using titanium-doped indium oxide as a transparent conductive film, and further disclose that an insertion loss of a Ti-diffused LN waveguide increases by using the transparent conductive film. Further, Japanese Laid-open Patent Publication No. 2007-272122 discloses that an insertion loss varies depending on a heat treatment temperature.

In recent years, for optical-communications applications, specifications have been established for optical modulators that integrate, inside the case, a driver that amplifies a modulation signal applied to the optical modulator. The heat generation of the driver is relatively large, and the temperature in the case becomes high by integrating the driver. As a result, the temperature inside the LN modulator increases, causing the DC drift phenomenon, an increase in the drive voltage, and further causing a deterioration in a propagation loss of the optical waveguide. Such a phenomenon in which the characteristics of the optical modulator are deteriorated due to heating is referred to as a “thermal degradation phenomenon”. In addition, in a case where the bias point control of the LN modulator is performed by using the TO effect, the thermal degradation phenomenon is likely to occur in the vicinity of the heater electrode.

Further, intensive investigation by the present inventor has revealed that, to efficiently change the refractive index of the optical waveguide formed in LN, using the transparent conductive film as the electrode in the vicinity of the optical waveguide causes the following phenomena due to a thermal load.
After the thermal load is applied to the optical control element using LN (referred to as a “thermal budget”), the DC drift phenomenon is likely to occur (increase in DC drift).
The drive voltage (Vπ) varies depending on a temperature of the thermal load (thermal budget).
The optical insertion loss varies depending on the temperature of the thermal load (thermal budget).

For this reason, the LN modulator using the transparent conductive film cannot ensure reliability and is therefore not used on a commercial basis.

One presumed cause of the degradation in the characteristics of the optical control element under the thermal load (thermal budget) is the diffusion of Li contained in the LN substrate into the transparent conductive film. Further, not only the transparent conductive film but also various film bodies or the like are in contact with the LN substrate. Specific examples of the film bodies include a support substrate 2 in contact with an electro-optical substrate 1 as shown in FIG. 2, an intermediate layer 21 disposed between the electro-optical substrate 1 and a support substrate 20 as shown in FIG. 3, a buffer layer 5 that covers a surface of the electro-optical substrate 1 as shown in FIG. 4, and an optical waveguide 6 disposed on the electro-optical substrate 1 as shown in FIG. 5.

In the film bodies or the like shown in FIGS. 2 to 5, it is considered that Li diffuses into the film bodies or the like due to the thermal load (thermal budget) and contributes to the occurrence of the DC drift phenomenon. In particular, when the electro-optical substrate is a thin film, as in TFLN, Li-metal vacancies formed by the diffusion of Li are more numerous within a thin-film substrate to which the electric field is applied, so the DC drift phenomenon becomes more pronounced.

### SUMMARY OF THE INVENTION

An object of the present invention is to solve the above-described issues and to provide an optical control element capable of suppressing a thermal degradation phenomenon even when a film body or the like, into which lithium can diffuse, is disposed in the vicinity of an electro-optical substrate containing lithium. Another object of the present invention is to provide an optical modulation device using the optical control element and an optical transmission apparatus.

In order to achieve the above-described objects, the optical control element, the optical modulation device using the optical control element, and the optical transmission apparatus according to aspects of the present invention have the following technical features.

(1) An optical control element includes an electro-optical substrate that contains lithium and in which an optical waveguide is formed, and electrodes that apply an electric field to the optical waveguide, in which a diffusion layer into which lithium contained in the electro-optical substrate is able to diffuse is disposed in the vicinity of the electro-optical substrate, and a block layer that suppresses diffusion of lithium is disposed between the electro-optical substrate and the diffusion layer.

(2) In the optical control element according to the above-described (1), the diffusion layer may be a transparent conductive film that constitutes at least a part of the electrodes.

(3) In the optical control element according to the above-described (1), the diffusion layer may be a support substrate that supports the electro-optical substrate or an intermediate layer provided between the electro-optical substrate and the support substrate.

(4) In the optical control element according to the above-described (1), the diffusion layer may be a buffer layer provided on the electro-optical substrate.

(5) In the optical control element according to the above-described (1), the diffusion layer may be an optical waveguide made of silicon.

(6) In the optical control element according to any one of the above-described (1) to (5), the block layer may be a silicon nitride film.

(7) In the optical control element according to the above-described (6), a thickness of the block layer may be 50 nm or higher and 100 nm or lower.

(8) An optical modulation device includes the optical control element according to the above-described (1) that is accommodated in a case of the optical modulation device, and an optical fiber that inputs a light wave to the optical control element or outputs the light wave from the optical control element.

(9) In the optical modulation device according to the above-described (8), the electrodes may include at least a modulation electrode for modulating a light wave propagating through the optical waveguide, and an electronic circuit that amplifies a modulation signal input to the modulation electrode is provided in the case.

(10) An optical transmission apparatus includes the optical modulation device according to the above-described (8), a light source that inputs a light wave to the optical modulation device, and an electronic circuit that outputs a modulation signal to the optical modulation device.

According to the aspects of the present invention, the optical control element includes the electro-optical substrate that contains lithium and in which the optical waveguide is formed, and the electrodes that apply the electric field to the optical waveguide, in which the diffusion layer into which lithium contained in the electro-optical substrate is able to diffuse is disposed in the vicinity of the electro-optical substrate, and the block layer that suppresses the diffusion of lithium is disposed between the electro-optical substrate and the diffusion layer, so that the diffusion of lithium into the diffusion layer is suppressed, and as a result, it is possible to provide the optical control element in which the occurrence of the thermal degradation phenomenon is suppressed. Furthermore, it is possible to provide the optical modulation device using the optical control element and the optical transmission apparatus.

### BRIEF DESCRIPTION OF THE DRAWINGS

FIG. 1 is a view showing a related-field example of an optical control element, in which a transparent electrode (transparent conductive film) is disposed.

FIG. 2 is a view showing a related-field example of the optical control element, in which a support substrate that supports an electro-optical substrate is used.

FIG. 3 is a view showing a related-field example of the optical control element, in which an intermediate layer is provided between the electro-optical substrate and the support substrate.

FIG. 4 is a view showing a related-field example of the optical control element, in which a buffer layer is disposed on the electro-optical substrate.

FIG. 5 is a view showing a related-field example of the optical control element, in which another optical waveguide is disposed on the electro-optical substrate.

FIG. 6 is a view showing an example of an optical control element according to an embodiment of the present invention, in which a transparent electrode (transparent conductive film) is disposed.

FIG. 7 is a view showing an example of the optical control element according to the embodiment of the present invention, in which a support substrate that supports an electro-optical substrate is used.

FIG. 8 is a view showing an example of the optical control element according to the embodiment of the present invention, in which an intermediate layer is provided between the electro-optical substrate and the support substrate.

FIG. 9 is a view showing an example of the optical control element according to the embodiment of the present invention, in which a buffer layer is disposed on the electro-optical substrate.

FIG. 10 is a view showing an example of the optical control element according to the embodiment of the present invention, in which another optical waveguide is disposed on the electro-optical substrate.

FIG. 11A is a view showing a manufacturing process of an example of the optical control element according to the embodiment of the present invention, FIG. 11B is a view showing a manufacturing process of an example of the optical control element according to the embodiment of the present invention, and FIG. 11C is a view showing a manufacturing process of an example of the optical control element according to the embodiment of the present invention.

FIG. 12D is a view showing the manufacturing process following FIGS. 11A to 11C, FIG. 12E is a view showing the manufacturing process following FIGS. 11A to 11C, and FIG. 12F is a view showing the manufacturing process following FIGS. 11A to 11C.

FIG. 13 is a plan view showing a shape of an electrode used in the optical control element according to the embodiment of the present invention.

FIG. 14 is a plan view showing another shape of the electrode used in the optical control element according to the embodiment of the present invention.

FIG. 15 is a view showing a state in which an electric field is applied to the optical control element according to the embodiment of the present invention.

FIG. 16 is a view showing an example in a case where the optical control element of FIG. 15 is replaced with a model of an electric circuit.

FIG. 17 is a view showing a relationship between thicknesses of the block layer and the transparent conductive film and a height of a rib-type optical waveguide in the optical control element according to the embodiment of the present invention.

FIG. 18 is a view showing a positional relationship between the transparent conductive film and a metal electrode disposed thereon in the optical control element according to the embodiment of the present invention.

FIG. 19 is a view showing an application example of the optical control element (FIG. 12F) according to the embodiment of the present invention.

FIG. 20 is a view showing an application example of the optical control element (FIGS. 7 and 9) according to the embodiment of the present invention.

FIG. 21 is a view showing an application example of the optical control element (FIG. 10) according to the embodiment of the present invention.

FIG. 22 is a view showing an example of an optical transmission apparatus according to the embodiment of the present invention.

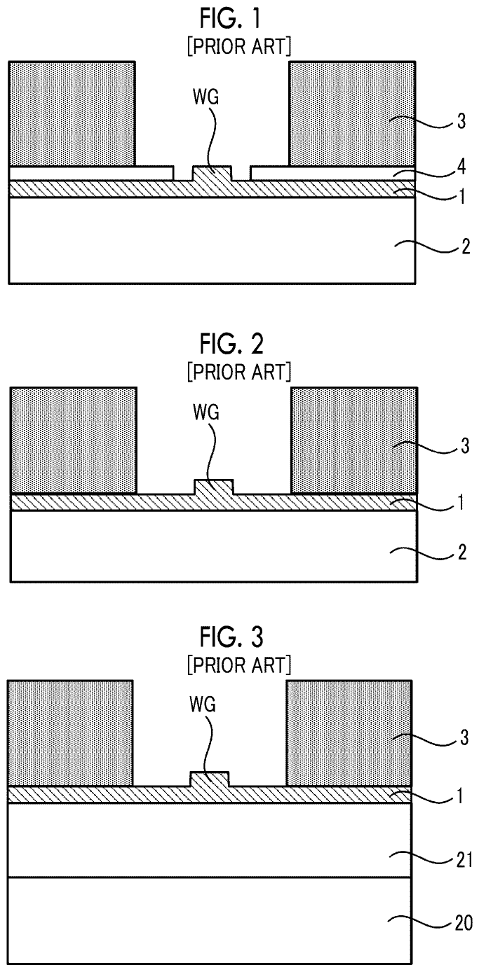

### DETAILED DESCRIPTION OF THE INVENTION

Hereinafter, an optical waveguide device according to an embodiment of the present invention will be described in detail using preferred examples.

As shown in FIGS. 6 to 10, the optical control element according to the embodiment of the present invention includes an electro-optical substrate 1 that contains lithium and in which an optical waveguide WG is formed, and electrodes 3 that apply an electric field to the optical waveguide, in which a diffusion layer (4, 2, 21, 5, 6) into which lithium contained in the electro-optical substrate is able to diffuse is disposed in the vicinity of the electro-optical substrate 1, and a block layer (BL1 to BL5) that suppresses diffusion of lithium is disposed between the electro-optical substrate and the diffusion layer.

Examples of the “electro-optical substrate that contains lithium” used in the present invention include lithium niobate and lithium tantalate.

As the electrode, Au or the like is used, and Ti, Cr, or the like is used as a base electrode when the electrode is formed.

FIG. 6 is a view showing an example in a case where the transparent conductive film (transparent electrode) 4 corresponds to the diffusion layer.

In the present invention, the transparent conductive film (transparent electrode) means a material that is conductive and is more transparent than metal in a wavelength range of light waves to be used. Examples of the material of the transparent conductive film include ITO, ZnO, and SnO₂. When the transparent conductive film is directly formed on an LN substrate using these materials, the diffusion of Li is confirmed in all the ITO, ZnO, and SnO₂ transparent conductive films by applying a thermal load (for example, 600 °C for 1 hour in air atmosphere). The diffusion of Li into the transparent conductive film causes a “thermal degradation phenomenon” in which the DC drift, the drive voltage, and the propagation loss of the optical waveguide are deteriorated. Since Si is transparent in an infrared region and has a low electrical resistance, Si can be used as the transparent conductive film. As will be described later, a Li diffusion phenomenon also occurs in Si.

In the optical control element according to the embodiment of the present invention, the film (block layer) BL1 that suppresses the diffusion of Li is disposed between the electro-optical substrate 1 and the transparent conductive film 4 that is the diffusion layer. By disposing the block layer, the diffusion of Li contained in the electro-optical substrate 1 into the transparent conductive film 4 due to the thermal load is suppressed.

The following items are required as conditions for the block film BL1 in FIG. 6.
Being optically transparent.
The refractive index is lower than that of the electro-optical substrate (LN substrate).
The diffusion of Li can be suppressed even when the film is thin.
Having a high dielectric constant.

The condition of “being optically transparent” is also required to suppress the optical insertion loss of the light wave propagating through the optical waveguide, since the optical waveguide WG is formed in the electro-optical substrate 1, and the block layer is also disposed close to the optical waveguide. In particular, it is required that the light wave is not absorbed.

The condition of “the refractive index is lower than that of the electro-optical substrate” is required to prevent a portion in which the block film BL1 is loaded on the electro-optical substrate 1 (TFLN) from functioning as the optical waveguide. When this portion functions as the optical waveguide, there is a possibility of interaction (optical coupling) with the original optical waveguide WG, which leads to greater degradation of characteristics of the optical control element and increased design complexity.

The condition of “the diffusion of Li can be suppressed even when the film is thin” is required since the insertion of the block film BL1 causes the electrode 3 to be separated from the electro-optical substrate 1 (optical waveguide WG), and thus the strength of the electric field formed by the electrode is weakened, and the efficiency of changing the refractive index of the optical waveguide is reduced. Therefore, it is required that a film thickness of the block layer is as small as possible. It goes without saying that, even when the film is thin, it is required that the diffusion of Li is suppressed.

The condition of “having a high dielectric constant” is required since, as will be described later, the dielectric constant affects the efficiency of changing the refractive index of the optical waveguide by using the EO effect, and this efficiency is reduced when the dielectric constant of the block film is low.

Silicon nitride (SiN) is preferable as the material forming the block layer. SiO₂ is provided as a material that satisfies some of the above-described conditions required for the block film.

In fact, a sample is prepared in which a SiN or SiO₂ film was formed on the LN substrate and an ITO film was formed thereon as the transparent conductive film, and a state of the diffusion of Li when the thermal load (600 °C for 1 hour in air atmosphere) was applied was examined. Further, the film thicknesses of SiN and SiO₂ were tested at 50 nm and 100 nm.

As a result, it was confirmed that SiN effectively suppresses the diffusion of Li even with the thickness of 50 nm, but the diffusion of Li was confirmed in the ITO film even with a thickness of 100 nm of SiO₂. From this result, it is understood that SiN is preferable as the block film, but SiO₂ is not suitable as the block film.

In addition, in a case where SiN is used as the block film, when the thickness of the block film is set to 50 nm or higher, it is possible to sufficiently suppress the diffusion of Li. In addition, the block film is more preferably set to 100 nm or lower from the viewpoint of suppressing the increase in the drive voltage.

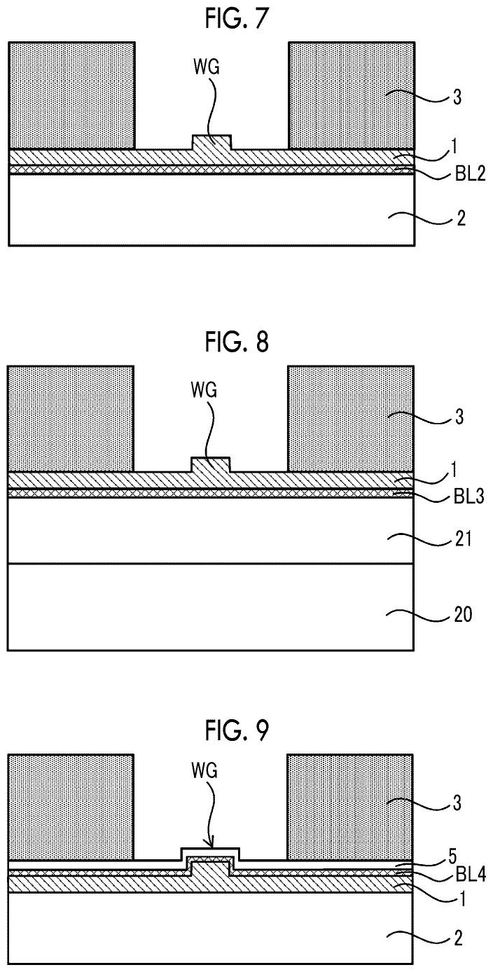

FIG. 7 is a view showing an example in a case where the support substrate 2 that supports the electro-optical substrate 1 corresponds to the diffusion layer.

In addition, FIG. 8 is a view showing an example in a case where the intermediate layer 21 is disposed between the electro-optical substrate 1 and the support substrate 20 and the intermediate layer 21 corresponds to the diffusion layer.

Hereinafter, an example will be described in which SiO₂ is used for the support substrate 2 or the intermediate layer 21, but the present invention is not limited thereto, and the present invention can be similarly applied in a case where a material into which Li can diffuse is used.

FIGS. 7 and 8 show a configuration of the optical control element including TFLN (electro-optical substrate), a configuration is used in which TFLN is attached to a SiO₂ wafer that is the support substrate 2 as shown in FIG. 7, or a configuration is used in which TFLN is attached to a thermally-oxidized Si wafer (provided with a support substrate 20 of Si and an intermediate layer 21 of SiO₂) as shown in FIG. 8. In the cases of FIG. 7 and FIG. 8 as well, LN and SiO₂ are in contact with each other, and when such a TFLN wafer is used to manufacture a TFLN modulator using the electro-optic effect, the DC drift phenomenon occurs.

In a case where TFLN and SiO₂ are directly joined to each other, Li ions diffuse into SiO₂ due to the thermal budget. In addition, Li-metal vacancies are generated in LN, and charges corresponding to the Li ions are generated. When the voltage is applied to the electrode to form the electric field in the optical waveguide of TFLN, the Li ions and the Li-metal vacancies move due to the electric field with the passage of time to form line of electric force between the Li ions and the Li-metal vacancies. Since the line of electric force are opposite to a direction of the electric field formed by the electrode, the electric field in the optical waveguide is attenuated with time. This phenomenon is a DC drift phenomenon.

In order to suppress the DC drift phenomenon, the SiN films (block layers BL2 and BL3) having a thickness of about 50 nm are inserted between the SiO₂ wafer (support substrate 2) and TFLN (electro-optical substrate) in FIG. 7 or between the thermally-oxidized Si wafer (intermediate layer 21 of SiO₂) and TFLN (electro-optical substrate)in FIG. 8. As described above, SiN has a high effect of suppressing the diffusion of Li, and a sufficient effect can be expected when SiN has a thickness of 50 nm or higher.

As conditions required for the block layers (BL2 and BL3), it is important that the block layers do not affect the strength of the electric field applied to the optical waveguide WG, the dielectric constant is preferably lower than that of the electro-optic substrate, and there is no particular limitation on the upper limit of the layer thickness.

FIG. 9 is a view showing an example in a case where the buffer layer 5 corresponds to the diffusion layer.

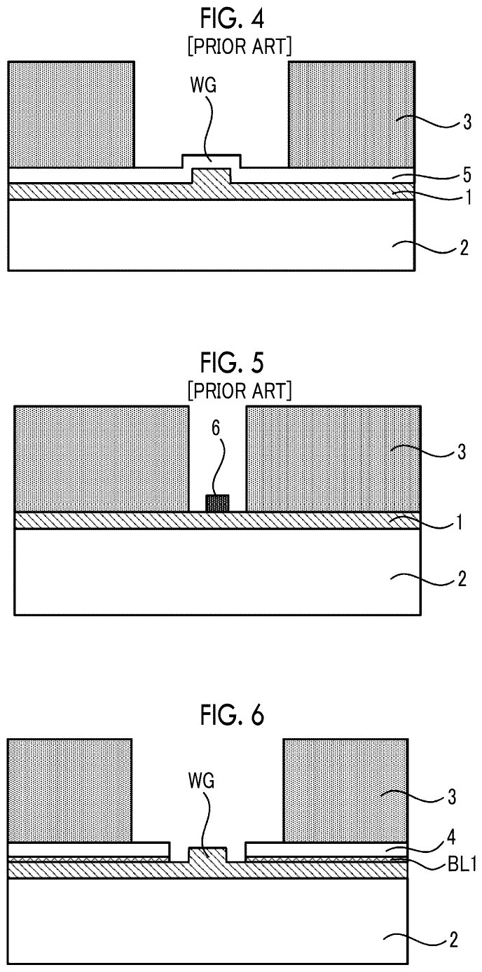

The SiO₂ film, which is the buffer layer 5, is inserted between the electro-optical substrate (TFLN substrate) 1 in which the optical waveguide is formed and the electrode 3, and the absorption of the light wave propagating through the optical waveguide by the electrode is suppressed. As shown in FIG. 4, when the buffer layer is formed in contact with the LN, Li diffuses into SiO₂, and the DC drift phenomenon is likely to occur. For this reason, in FIG. 9, the SiN film (block layer BL4) is inserted between LN (electro-optical substrate 1) and SiO₂ (buffer layer 5) in order to suppress the diffusion of Li. In addition, SiO₂ has a small amount of the diffusion of Li compared to the transparent conductive film. For this reason, although the DC drift phenomenon occurs, neither the increase in the drive voltage nor the increase in the optical insertion loss is observed. In addition, the conditions required for the block layer BL4 of FIG. 9 are basically the same as the above-described conditions required for the block layer BL1 of FIG. 6.

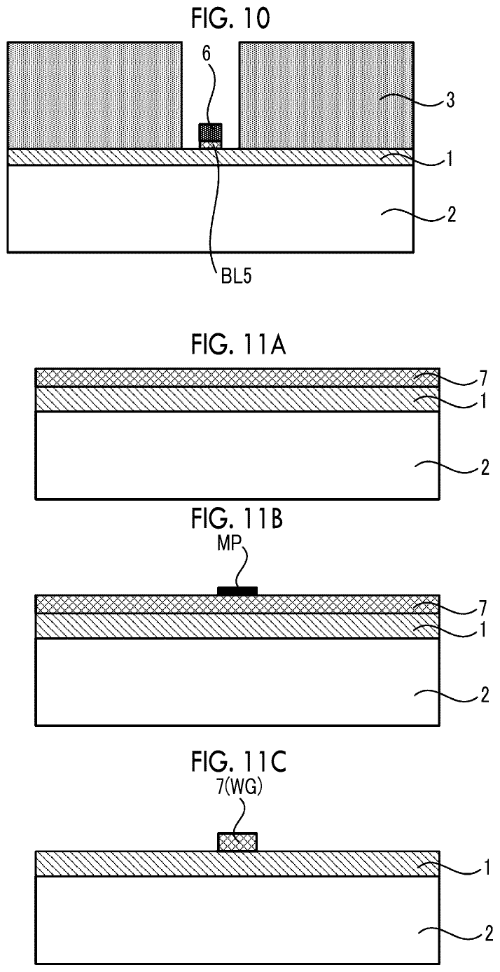

FIG. 10 is a view showing an example in a case where another optical waveguide 6 disposed on the electro-optical substrate 1 corresponds to the diffusion layer.

As shown in FIG. 5, the optical control elements having a shape in which the optical waveguide made of Si is directly loaded on TFLN or in which the optical waveguide of Si and TFLN are joined to each other via SiO₂ have been developed. The Li diffusion phenomenon also occurs in Si due to the thermal load. Further, as described above, it is difficult to suppress the diffusion of Li with SiO₂.

For this reason, as shown in FIG. 10, the SiN film that is the block layer BL5 is inserted between Si or SiO₂ forming another optical waveguide 6 and the electro-optical substrate TFLN, and thus the thermal degradation phenomenon can be suppressed.

By forming amorphous Si (a-Si) patterned on TFLN, it is possible to manufacture a TFLN waveguide loaded with the optical waveguide of Si. The thermal degradation phenomenon also occurs in the optical waveguide of Si due to the thermal load, but the thermal degradation phenomenon can be suppressed by inserting the SiN film between Si and TFLN.

As conditions required for the block layer in the case of FIG. 10, A thinner thickness of the block layer is preferable in a case where the interaction such as the light wave moving between the optical waveguide formed on the electro-optical substrate 1 and another optical waveguide 6 is expected. However, in a portion in which no interaction is expected, there is no particular limitation on the thickness of the block layer.

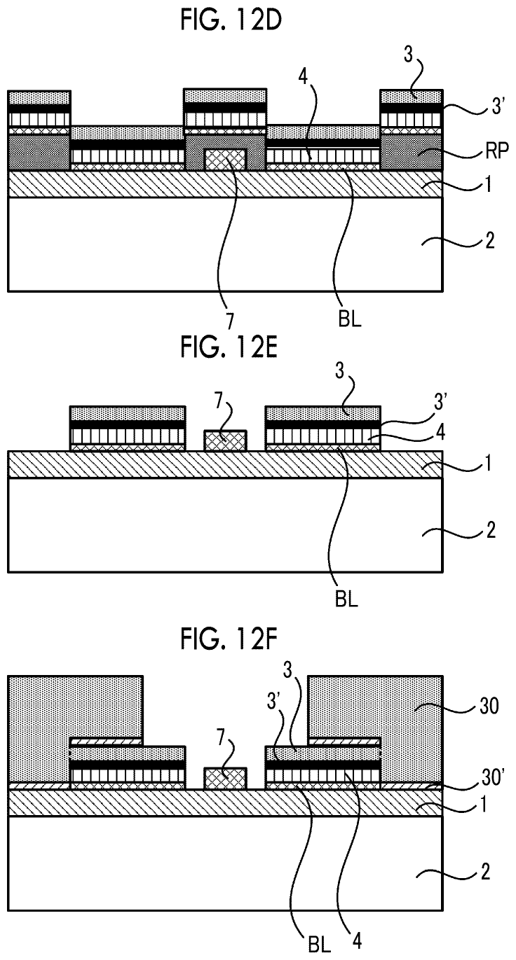

Next, a manufacturing procedure will be described using FIGS. 11A to 12F for an example of the optical control element using the transparent conductive film.

As shown in FIG. 11A, an Xcut-TFLN substrate 1 having a thickness of about 0.4 μm is prepared, and a SiN film 7 having a thickness of about 0.3 to 0.6 μm is formed by reactive sputtering. Since a heat resistant temperature of TFLN is said to be about 600 °C, it is necessary to form a film at a relatively low temperature. The TFLN substrate 1 is disposed on the support substrate 2.

Then, as shown in FIG. 11B, a pattern MP of a Cr film having a thickness of 30 nm is formed on the SiN film by using a lithography technique. In this pattern forming method, the roughness of the edge portion of the Cr film is reduced when a lift-off method is used rather than a wet etching method.

As shown in FIG. 11C, the pattern (MP) of the Cr film is transferred to the SiN film 7 by dry etching. For the dry etching, a mixed gas of CHF₃ and O₂ can be used. The remaining Cr film is removed with a commercially available Cr etching solution (main component: diammonium cerium (IV) nitrate), and then heat treatment at 400 °C is performed in the atmosphere.

As shown in FIG. 12D, after the pattern of the resist is formed by using the lithography technique, SiN (BL), ITO (4), Cr (3′), and Au (3) films are sequentially formed. The SiN and ITO films are formed by reactive sputtering, and the Cr and Au films are formed by vacuum deposition.

The thicknesses are 50 nm, 200 nm, 50 nm, and 300 nm, respectively.

After the film was formed as shown in FIG. 12D, the resist (RP) was dissolved to form a pattern of laminated films (SiN (BL), ITO (4), Cr (3′), and Au (3)) on TFLN (1) as shown in FIG. 12E.

Thereafter, as shown in FIG. 12F, an electrode (30) corresponding to the intended use is formed. The electrode (30) is made of Au, and Ti is used as the base electrode (30′).

In the optical control element of FIG. 12F, the vicinity of SiN (7) functions as the optical waveguide in TFLN (1).

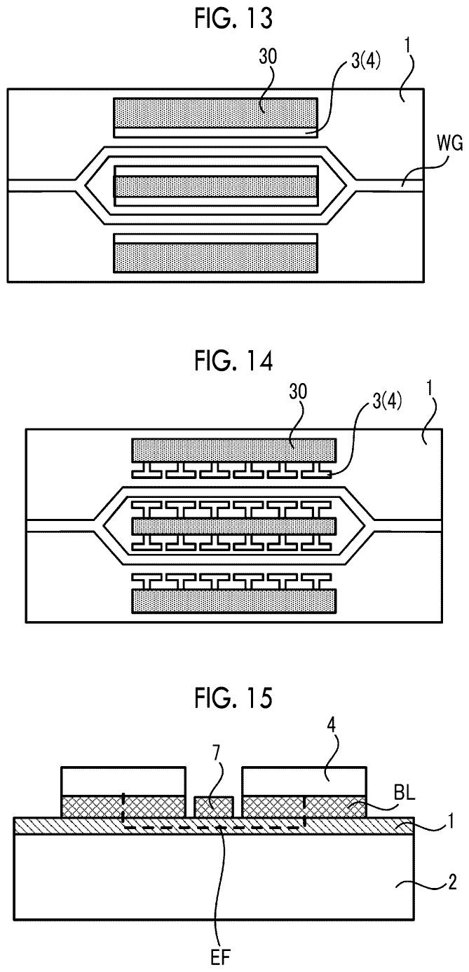

As for the shapes of the electrode 3 (transparent conductive film 4) located in the vicinity of the optical waveguide and the thicker electrode 30, various shapes can be employed, one example of the various shapes is shown in the plan views of FIGS. 13 and 14.

In FIG. 13, both the electrode 3 and the electrode 30 are disposed linearly along the optical waveguide WG. On the other hand, in FIG. 14, the electrode 3 is a set of T-shaped segment electrodes.

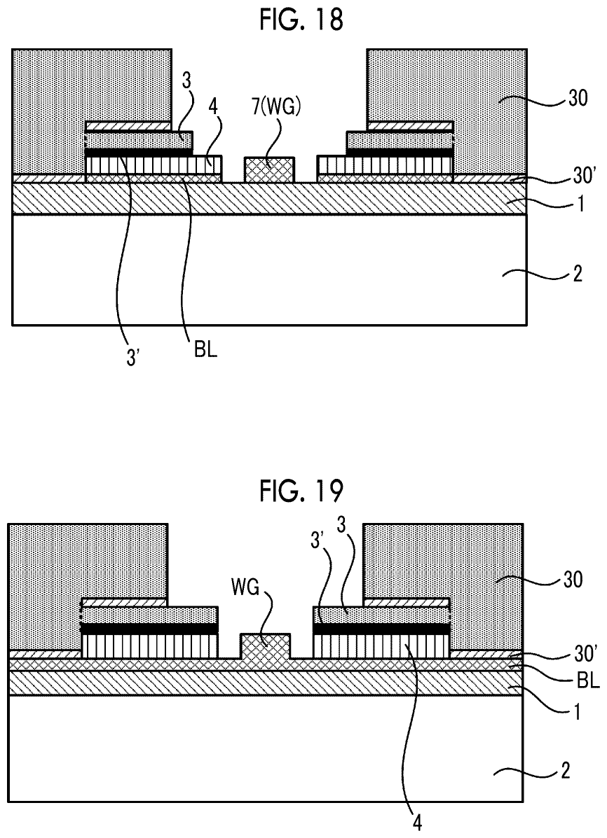

In addition, the electrode 3 is not only in a state where a metal electrode 3 is disposed on the transparent conductive film 4 as shown in FIG. 12F, but also may, for example, employ a configuration in which a part of the electrode 3 is removed, and the transparent conductive film 4 is exposed in the vicinity of the optical waveguide, as shown in FIG. 18.

Next, the conditions (dielectric constant, thickness) for the block layer disposed between the electro-optical substrate and the transparent conductive film will be described using a model.

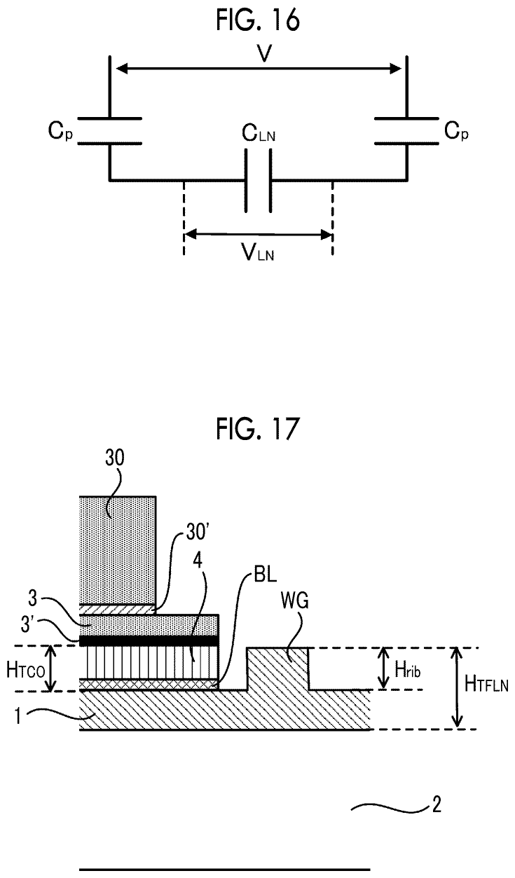

FIG. 15 is a simple model in which the block layer BL is disposed between the electro-optical substrate (LN) 1 and the transparent conductive film 4. FIG. 16 is a view in which a portion indicated by a dashed line EF in FIG. 15 is represented by the electric circuit.

A relationship between a voltage V applied to the two transparent conductive films 4 in FIG. 15 and a voltage V_{LN} in the electro-optical substrate 1 including the optical waveguide is expressed by the following expression.

V_{LN}/V=(C_{P}/C_{LN})/(2+C_{P}/C_{LN})

Here, C_{P} is a capacitance in the block layer, and C_{LN} is a capacitance in the electro-optical substrate.

Here, the condition for maximizing V_{LN}/V is to increase the value of C_{P}. In other words, it is effective to increase the dielectric constant of the block layer or to further reduce the thickness of the block layer.

Therefore, as shown in FIG. 15, in a case where the block layer BL is disposed in the middle of dashed line EF to which the electric field of the electrode is applied, it is preferable to increase the dielectric constant of the material forming the block layer and to reduce the thickness of the block layer.

Next, a method of further suppressing the optical insertion loss using the transparent conductive film will be described with reference to FIGS. 17 and 18.

FIG. 17 shows an overall thickness H_{TCO} of the block layer BL and the transparent conductive film 4 disposed thereon, which is greater than a height (H_{rib}) of the optical waveguide (rib-type optical waveguide) WG. Accordingly, it is possible to move the electrode 3 made of metal disposed above the transparent conductive film 4 away from the optical waveguide WG, and it is possible to suppress the absorption of the propagated light by the electrode 3. Specifically, the film thickness (H_{TFLN}) of TFLN is about 0.4 to 0.5 μm, and the rib height is about 0.2 to 0.25 μm. When considering a tolerance of about twice the rib height, H_{TCO}>0.5 μm. In this case, even when the relative positions of the optical waveguide and the electrode 3 are shifted, the optical loss is unlikely to increase, and thus the tolerance related to the alignment is increased.

In FIG. 18, after the process of FIG. 12E, the metal electrodes (3, 3′) in the vicinity of the optical waveguide are retracted by wet etching of Au and Cr, and the absorption of the metal electrode is suppressed without increasing the drive voltage.

Hereinafter, application examples of the various optical control elements described above will be described.

In FIG. 19, instead of leaving only the SiN film (7) in the optical waveguide portion as in FIG. 11C, the SiN film outside the optical waveguide is left thin and used as the block layer (BL). Accordingly, it is possible to omit the process of separately forming the block layer in FIG. 12D.

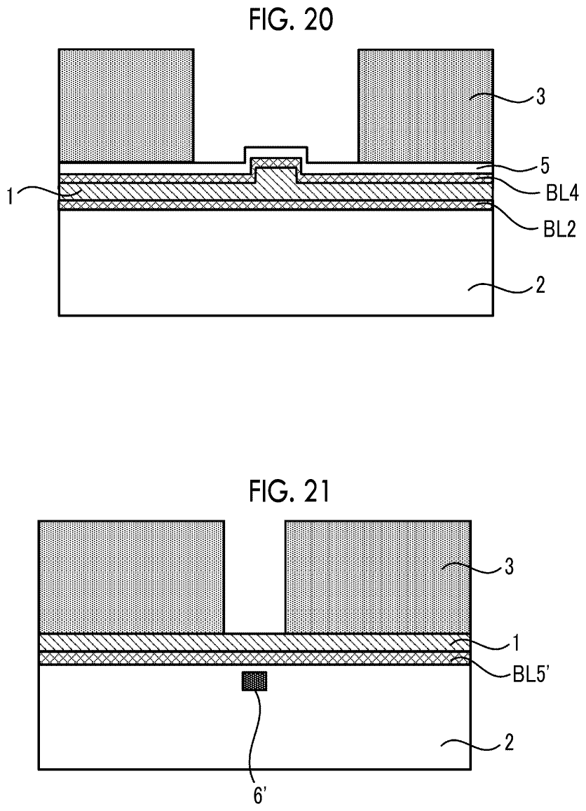

FIG. 20 is a combination of the optical control elements in FIGS. 7 and 9, and in a case where the SiO₂ films as the support substrate 2 or the buffer layer 5 are present to interpose the electro-optical substrate 1, the block layers (BL2 and BL4) may be disposed on the upper and lower surfaces in contact with the electro-optical substrate 1.

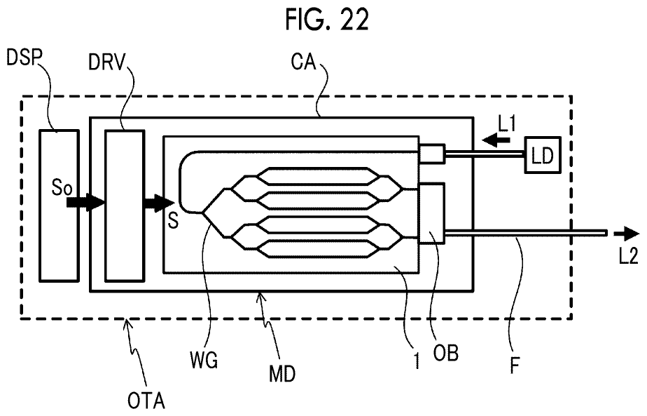

FIG. 21 shows an application example of the optical control element of FIG. 10, in which an optical waveguide 6′ of Si is formed in SiO₂ forming the support substrate 2. In such a case as well, the thermal degradation phenomenon can be suppressed by disposing the SiN block layer (BL5′) between the electro-optical substrate 1 and the support substrate 2.

Next, an example will be described in which the optical control element according to the embodiment of the present invention is applied to an optical modulation device or an optical transmission apparatus. While an example of a high bandwidth-coherent driver modulator (HB-CDM) will be used in the following description, the present invention is not limited to the example, and can also be applied to an optical phase modulator, an optical modulator having a polarization combining function, an optical waveguide device in which a larger or smaller number of Mach-Zehnder type optical waveguides are integrated, a device joined to an optical waveguide device made of other materials such as silicon, a device used as a sensor, and the like.

As shown in FIG. 22, the optical control element forms the optical waveguide WG on the electro-optical substrate 1 such as TFLN. In addition, the electro-optical substrate is provided with a control electrode (not shown) such as a modulation electrode for modulating a light wave propagating through the optical waveguide or a DC bias electrode. The optical control element is accommodated in the case CA. Moreover, an optical modulation device MD can be configured by providing an optical fiber (F) that inputs the light waves to the optical waveguide and outputs the light waves from the optical waveguide.

In FIG. 22, the optical fiber F is optically coupled to the optical waveguide WG inside the optical waveguide device using an optical block including an optical lens, a lens barrel, a polarization Y-branch coupler OB, and the like. The present invention is not limited to this configuration, and an optical fiber may be introduced into the case through a through-hole penetrating a side wall of the case, and an optical component or a substrate may be directly joined to the optical fiber, or an optical fiber having a lens function at an optical fiber end portion may be optically coupled to the optical waveguide in the optical waveguide device. In addition, in order to stably join the optical fiber or the optical block, a reinforcing member (not shown) may be disposed to overlap an end surface of the electro-optical substrate.

An optical transmission apparatus OTA can be configured by connecting, to the optical modulation device MD, an electronic circuit (digital signal processor DSP) that outputs a modulation signal So for causing the optical modulation device MD to perform the modulation operation. In order to obtain a modulation signal S applied to the optical waveguide device, it is necessary to amplify the modulation signal So output from the digital signal processor DSP. For this reason, in FIG. 22, a driver circuit DRV is used to amplify the modulation signal. The driver circuit DRV and the digital signal processor DSP can be disposed outside the case CA, but can also be disposed inside the case CA. In particular, when the driver circuit DRV is disposed inside the case, the propagation loss of the modulation signal from the driver circuit can be further reduced.

While input light L1 to the optical modulation device MD may be supplied from the outside of the optical transmission apparatus OTA, a semiconductor laser (LD) can also be used as a light source as shown in FIG. 22. Output light L2, which is modulated by the optical modulation device MD, is output to the outside through the optical fiber F.

As described above, according to the embodiment of the present invention, it is possible to provide the optical control element capable of suppressing the thermal degradation phenomenon even when the film body or the like, into which lithium can diffuse, is disposed in the vicinity of the electro-optical substrate containing lithium. Further, it is possible to provide the optical modulation device using the optical control element and the optical transmission apparatus.

What is claimed is:

1. An optical control element comprising:
an electro-optical substrate that contains lithium and in which an optical waveguide is formed; and
electrodes that apply an electric field to the optical waveguide,
wherein a diffusion layer into which lithium contained in the electro-optical substrate is able to diffuse is disposed in the vicinity of the electro-optical substrate, and
a block layer that suppresses diffusion of lithium is disposed between the electro-optical substrate and the diffusion layer.

2. The optical control element according to claim 1,
wherein the diffusion layer is a transparent conductive film that constitutes at least a part of the electrodes.

3. The optical control element according to claim 1,
wherein the diffusion layer is a support substrate that supports the electro-optical substrate or an intermediate layer provided between the electro-optical substrate and the support substrate.

4. The optical control element according to claim 1,
wherein the diffusion layer is a buffer layer provided on the electro-optical substrate.

5. The optical control element according to claim 1,
wherein the diffusion layer is an optical waveguide made of silicon.

6. The optical control element according to claim 1,
wherein the block layer is a silicon nitride film.

7. The optical control element according to claim 6,
wherein a thickness of the block layer is 50 nm or more and 100 nm or less.

8. An optical modulation device comprising:
the optical control element according to claim 1 that is accommodated in a case of the optical modulation device; and
an optical fiber that inputs a light wave to the optical control element or outputs the light wave from the optical control element.

9. The optical modulation device according to claim 8,
wherein the electrodes include at least the modulation electrode for modulating the light wave propagating through the optical waveguide, and
an electronic circuit that amplifies a modulation signal input to the modulation electrode is provided in the case.

10. An optical transmission apparatus comprising:
the optical modulation device according to claim 8;
a light source that inputs the light wave to the optical modulation device; and
an electronic circuit that outputs a modulation signal to the optical modulation device.
